(19) United States
(12) Patent Application Publication
(10) Pub. No.: US 2016/0057618 A1
(43) Pub. Date: Feb. 25, 2016

(54) MASK THAT PROVIDES PRIVACY IN TELEPHONE COMMUNICATIONS CONDUCTED IN PUBLIC

(71) Applicant: Arthur Shorr, Rancho Mirage, CA (US)

(72) Inventor: Arthur Shorr, Rancho Mirage, CA (US)

(21) Appl. No.: 14/834,574

(22) Filed: Aug. 25, 2015

Related U.S. Application Data
(60) Provisional application No. 62/041,300, filed on Aug. 25, 2014.

(51) Int. Cl. H04W 12/02; H04M 1/60

(52) U.S. Cl. CPC H04W 12/02; H04M 1/6058; H04M 1/6066

(57) ABSTRACT

A masklike device that provides privacy to a user during a telephone conversation conducted while the user is in a public location, and that prevents the user from making utterances or noises that would disturb others in close proximity (e.g., a distance that would normally be considered within earshot) of the user.

### CROSS-REFERENCE TO RELATED APPLICATIONS

This application claims priority to and the benefit of co-pending U.S. provisional patent application Ser. No. 62/041,300, filed Aug. 25, 2014.

### STATEMENT REGARDING FEDERALLY FUNDED RESEARCH OR DEVELOPMENT

NOT APPLICABLE.

### THE NAMES OF THE PARTIES TO A JOINT RESEARCH AGREEMENT

NOT APPLICABLE.

### INCORPORATION-BY-REFERENCE OF MATERIAL SUBMITTED ON A COMPACT DISC

NOT APPLICABLE.

### FIELD OF THE INVENTION

The invention relates to electronic communication devices in general and particularly to a communication device that improves the privacy of oral communication.

### BACKGROUND OF THE INVENTION

Various devices are known in the art for limiting the range over which audible speech can be heard, for example to allow oral dictation in a courtroom by a court reporter. Other devices have been described that allow communication in what would otherwise be a noisy environment that would limit or prevent oral communication.

In previous times, structures such as enclosed telephone booths which were provided for users of some, but not all, public pay telephones served the purpose of allowing one to conduct a conversation with an expectation of privacy.

Today, given the ubiquitous prevalence of cellular telephones, or cellphones, it is often difficult to hold a telephone conversation without disturbing persons who are close to the cellphone user. In some instances, public conveyances such as commuter trains have instituted “quiet cars” in which cellphone usage is prohibited, in order to accommodate those who want to ride in a quiet environment.

In other circumstances, a person who talks on a cellphone often finds that it is difficult to find a location where a conversation can be conducted in private. As will be understood, conversations of a personal nature, such as those that deal with medical issues or that deal with intimate interpersonal relationships, and conversations that deal with sensitive business matters or with legal matters generally require that the human operator have an expectation of privacy.

A device known as a Steno Mini Mask or Mask Reporter microphone is used by stenographers to report on court room proceedings without being heard. It is a private hand held mask allowing the verbatim mask reporter to report on the court proceedings (e.g., repeat statements made in the courtroom for transcription) quietly without interrupting others. The stenomask can be plugged into a variety of recording equipment. The Steno Mask Mini can be used with voice recognition computer software. It can also be used to provide extra clarity needed for use with a tape recorder, and wireless language equipment. The Steno Mini Mask is available from Martel Electronics Sales Inc., 23221 E. La Palma Avenue, Yorba Linda, Calif. 92887.

Another device called the Sylencer® or Stenomask is a patented, ergonomically designed, hand-held device used to contain or silence the user's voice as well as excluding unwanted noise from outside. Inside is a special microphone allowing the user to transmit, record or communicate without being overheard by others. In essence, the Sylencer/Stenomask functions like a portable sound booth allowing quiet and private communication. The user holds the Sylencer against the face while speaking into the microphone inside the housing. The Sylencer can be plugged into a variety of equipment including recorders, transmitters, phones, amplifiers and computers. The Sylencer® is available from Talk Technologies Inc., Los Angeles, Calif.

Over the years, various device patents have been issued that were intended to prevent persons near a speaker from hearing the comments of the speaker. In general, all these previous devices were cumbersome, expensive, of poor voice quality and/or did not provide hands-free telephone capability.

Known in the prior art is G. M. O. Jenkins, U.S. Pat. No. 1,368,261, issued Feb. 15, 1921, which is said to disclose a type of mounting especially suitable for use in connection with transmitters used on aeroplanes for communication between the pilot and the observer, or between various observers.

Also known in the prior art is H. L. Webb, U.S. Pat. No. 2,882,355, issued Apr. 14, 1959, which is said to disclose an ambient sound-excluding mask device of the type used for recording speech in electric dictating machines as for “court reporting” and as generally exemplified by such patents as U.S. Pat. Nos. 2,526,177, 2,572,547 and 2,625,615.

Also known in the prior art is R. L. Karns, U.S. Pat. No. 3,244,816, issued Apr. 5, 1966, which is said to disclose a system for audio training and a portable acoustical isolation chamber for use therein.

Also known in the prior art is Barry S. Todd, U.S. Pat. No. 3,497,623, issued Feb. 24, 1970, which is said to disclose a device, to be used in conjunction with at least one other similar device, comprising a telephone hand set or head set which is used or worn by each member of a conference. The hand set or head set comprises an audible noise generator positioned in above proximity to the user's mouth. The generator operates when the user is speaking and for some interval after he stops. A gate generator activates a chopper to permit voice signals to be transmitted to the earphone of another like device. During the transmission of a voice signal, an inverter deactivates another chopper to prevent noise from emanating from a noise output speaker. When a voice signal is not being transmitted, the chopper is deactivated and the inverter is activated to operate said other chopper and permit the generated noise to be heard through the noise output speaker. The gate generator is operated at a repetition rate which exceeds the Nyquist frequency necessary for a complete reconstructed speech signal to be transmitted to other listening stations.

Also known in the prior art is Eric L. Guille, U.S. Pat. No. 3,796,842, issued Mar. 12, 1974, which is said to disclose a dictation mask adaptable for use by a court reporter, or the like, which is electrically connected to a recording apparatus for recording the voice of the dictator. A generally spherically-shaped member providing an area for fitting on the face of the dictator and including a plurality of chambers serially in communication by means of sole apertures, and certain of the chambers having muffling coils mounted therein for receiving the breath and voice of the dictator and muffling the sound therefrom, and each such muffling coil provided with a plurality of spaced-apart breath exhaust passages, said spherically-shaped member being provided with a handle and said handle providing one of said plurality of chambers, and said dictation mask including moisture-absorbing means.

Also known in the prior art is Charles C. Johnson, U.S. Pat. No. 3,905,042, issued Sep. 9, 1975, which is said to disclose a remote control unit that is used to select between two or more magnetic tape recorders. A stenographic operator wearing a stenographic mask microphone connected to said remote control unit may record on any one of several magnetic tape recorders by simply turning a switch. The remote control unit also includes other recorder functions such as rewind, forward, letter or secretary indexing on a separate medium, audio input, and monitor. With the control unit, a courtroom stenographer may remotely control the functions of his recording devices and has the freedom to reload one while recording into another, without interrupting courtroom proceedings.

Also known in the prior art is Thomas A. Gore, U.S. Pat. No. 4,129,754, issued Dec. 12, 1978, which is said to disclose a hand-held reporting device for use in environments wherein a minimum of sound in connection with use of the device is a priority and in environments having a high level of noise intensity. The device includes a barrel with a bell-shaped top, the latter preferably being set at an angle with respect to the barrel. A microphone is positioned at the end of the barrel remote from the bell-shaped top. The barrel portion and a portion of the bell-shaped top are lined with foam urethane to muffle noise and absorb moisture. The reporting device includes means for permitting pressurized air within the device to escape to the outside via an air communication channel from inside the device through a portion of the face piece of the device to the outside.

Also known in the prior art is Figone et al., U.S. Pat. No. 4,834,212, issued May 30, 1989, which is said to disclose a human sound muffler and indicator for placement around the mouth of a user to absorb most of the sound emanating from the user's mouth including a microphone and associated electrical circuit for receiving unabsorbed sound and providing an indication of the intensity of the unabsorbed sound.

Also known in the prior art is Raoul E. Drapeau, U.S. Pat. No. 5,197,098, issued Mar. 23, 1993, which is said to disclose an audio system for conducting confidential multi-person conferences without the need for secure meeting facilities. Means for silently accepting spoken speech from a number of participants and making that speech available to all participants through headphones. Means for controlling the volume of the speech for each participant. Means for indicating which participant(s) are speaking Means for masking any incidental speech escaping from masks. Means for alerting participants when speech is escaping from a mask. Means to allow modular expansion of the number of participants. Means for recording the meeting for later listening or transcription.

Also known in the prior art is Cromack et al., U.S. Pat. No. 8,407,049, issued Mar. 26, 2013, which is said to disclose systems and methods for improving human conversations by enhancing conversation participants' ability to: Distill out and record core ideas of conversations. Classify and prioritize these key concepts. Recollect commitments and issues and take appropriate action. -Analyze and uncover new insight from the linkage of these ideas with those from other conversations.

There is a need for systems and methods for allowing oral communication without causing disruption to persons in close proximity to a speaker who do not wish to hear the conversation, and for allowing a speaker to communicate orally without others overhearing what the speaker is communicating.

### SUMMARY OF THE INVENTION

According to one aspect, the invention features an apparatus that provides privacy during spoken communication.

The apparatus comprises a structure configured to be worn by a human operator, the structure configured to enclose at least a mouth of the human operator, the structure configured to prevent an oral utterance of the human operator from being overheard by a listener who is not a party to a conversation with the human operator, the structure configured to allow the human operator to breathe without restriction, the structure configured to allow hands-free bi-directional oral communication by the human operator; a microphone situated within the structure, the microphone configured to be positioned relative to the mouth of the human operator so as to capture the oral utterance of the human operator and to provide as output an electrical signal representative of the oral utterance, the microphone connected by way of a first communication channel to an output terminal that is configured to provide the output electrical signal; at least one speaker configured to be in proximity to an ear of the human operator, the at least one speaker configured to provide an audible output signal to the ear of the human operator, the at least one speaker connected by way of a second communication channel to an input terminal, the input terminal configured to receive an input signal representative of the audible output signal; and a single unitary connector configured to connect both the input terminal and the output terminal to an electronic communication device so as to provide bi-directional communication capability between the apparatus and the electronic communication device.

In one embodiment, the electronic communication device is a cellular telephone handset.

In another embodiment, the electronic communication device is configured to communicate using the Voice over Internet Protocol.

In yet another embodiment, the electronic communication device is configured to communicate using a wireless electronic communication system.

In still another embodiment, the electronic communication device is configured to communicate using a wired electronic communication system.

In a further embodiment, at least one of the first communication channel, the second communication channel and the single unitary connector is configured as a wired connection.

In yet a further embodiment, at least one of the first communication channel, the second communication channel and the single unitary connector is configured as a wireless connection.

In an additional embodiment, the at least one speaker configured to be in proximity to an ear of the human operator is configured to prevent the audible output signal from being overheard by a listener who is not a party to the conversation with the human operator.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a diagram of one embodiment of the outermost layer of the device that illustrates an exemplary embodiment of a sound control device according to principles of the invention.

FIG. 1B is a diagram of an embodiment of the innermost layer of the device that illustrates an exemplary embodiment of a sound control device according to principles of the invention.

FIG. 1C is a diagram of another embodiment of the outermost layer of the device showing straps for attaching the device to the face of a user.

FIG. 1D is a diagram of another embodiment of the innermost layer of the device showing the attachment of the earbuds and a universal cellular telephone jack.

FIG. 1E is a schematic circuit diagram of an embodiment of the earbuds, one or more microphones and a universal cellular telephone jack.

FIG. 1F is a schematic diagram of an embodiment of a sound control device showing the location of two microphones M1 and M2 and two air vents in a sound control device according to principles of the invention.

FIG. 2 is a schematic diagram of an embodiment of a sound control device having five layers of a sound control device according to principles of the invention.

FIG. 3 is an illustration of an interior surface of an embodiment of a sound control device according to principles of the invention.

FIG. 4 is an illustration of the exterior of an embodiment of a sound control device according to principles of the invention.

FIG. 5 is an illustration of another embodiment of an external layer of a sound control device according to principles of the invention, showing the location of air vents and a location of an electrical input terminal.

FIG. 6 is an illustration in perspective of an embodiment of a sound control device according to principles of the invention situated on the face of a user.

FIG. 7 is a frontal illustration of an embodiment of a sound control device according to principles of the invention situated on the face of a user.

FIG. 8 is a schematic front view of an embodiment of a sound control device according to principles of the invention showing a location where a logo and/or trademark can be imprinted on the front of the device.

FIG. 9 is a frontal view of an embodiment of a sound control device according to principles of the invention showing the external form of a molded housing for the device and a strap.

FIG. 10 is an interval view of an embodiment of a sound control device according to principles of the invention.

FIG. 11 is an interval view of an embodiment of a sound control device according to principles of the invention.

FIG. 12 is an external view of an embodiment of a sound control device according to principles of the invention.

### DETAILED DESCRIPTION

The purpose of the device is to allow a human operator (also referred to as “a user”) to freely speak and listen on an electronic communication device, such as a cellphone, in relative privacy and not to unreasonably disturb nearby persons. Other electronic communication devices that can be used with the sound control device of the invention include but are not limited to electronic communication devices that are configured to communicate using the Voice over Internet Protocol (VoIP), such as a personal computer, a laptop computer, a palmtop computer or a tablet running a service or application such as Skype, Zoom, Go To Meeting, or the like. In addition, the sound control device of the invention can be employed with either or both of wired and wireless electronic communication systems. The electronic communication systems can be any system that accepts and provides analog audible signals, whether the actual electronic communication is analog or digital, wired or wireless. As used herein the term “electronic communication device” includes devices that communicate auditory signals using electromagnetic radiation that is transmitted and received at any frequency in the electromagnetic spectrum.

This invention provides a device to allow a passenger on an aircraft, or any public or private conveyance to hold a hands-free bi-directional telephone conversation while substantially reducing the sound levels from reaching nearby fellow passengers. Additionally the device can be used by a user to make oral audio recordings or notes while substantially reducing the sound levels from reaching nearby fellow passengers.

This device is a multi-layered face mask that encloses at least the mouth, and in some embodiments also the nose and the chin. In one embodiment, the device is secured by one or more elastic straps that pass around the back of the head. In some embodiments the device includes an adjustable strip that rests on the nose. The adjustable strip in some embodiments in made of plastic. In some embodiments, the elastic strap is provided with a hook and loop closure mechanism, such as hook and loop systems provided by Velcro™ material.

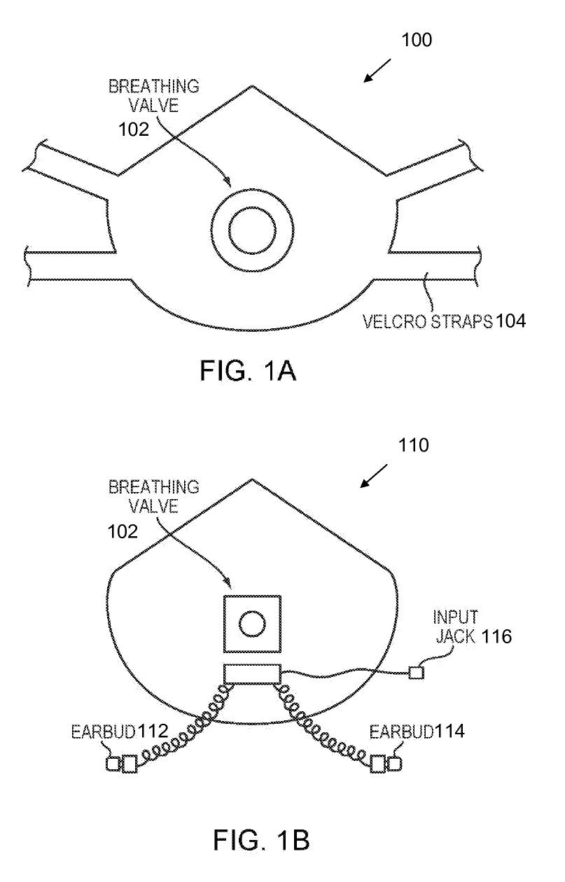

FIG. 1A is a diagram 100 of one embodiment of the outermost layer of the device that illustrates an exemplary embodiment of a sound control device according to principles of the invention. As illustrated in FIG. 1A, there is a breathing valve 102 and a plurality of straps 104 that hold the mask in position on the user's head.

FIG. 1B is a diagram 110 of an embodiment of the innermost layer of the device that illustrates an exemplary embodiment of a sound control device according to principles of the invention. As illustrated in FIG. 1B there is shown an embodiment in which the breathing valve 102 is illustrated along with an input jack 116 for making electrical connections to a communication device. Earbuds 112, 114 are provided so that the user can hear the conversation with another person. In some embodiments only one earbud is used. In other embodiments, two earbuds are used. In some embodiments, the earbuds, or another speaker used to provide an audible signal to the user is configured to prevent the audible signal from being overheard by a listener who is not a party to a conversation with the human operator.

FIG. 1C is a diagram 120 of another embodiment of the outermost layer of the device showing straps 124 for attaching the device to the face of a user. In the embodiment of FIG. 1C the straps are made of an elastic material, and are adjustable. The straps may be closed with any convenient closing mechanisms, such as a hook and eye closing system, such as Velcro™ material. In the embodiment of FIG. 1C there are shown a plurality of breathing valves or slots 122.

FIG. 1D is a diagram 130 of another embodiment of the innermost layer of the device showing the attachment of the earbuds 132, 134 and a universal cellular telephone jack 136. The inner parts of the plurality of breathing valves or slots 122 are also shown.

FIG. 1E is a schematic circuit diagram 140 of an embodiment of the earbuds 142, 144, one or more microphones 146 and a universal cellular telephone jack 148.

FIG. 1F is a schematic diagram 150 of an embodiment of a sound control device showing the location of two microphones M1 152 and M2 154 and two air vents 156, 158 in a sound control device according to principles of the invention.

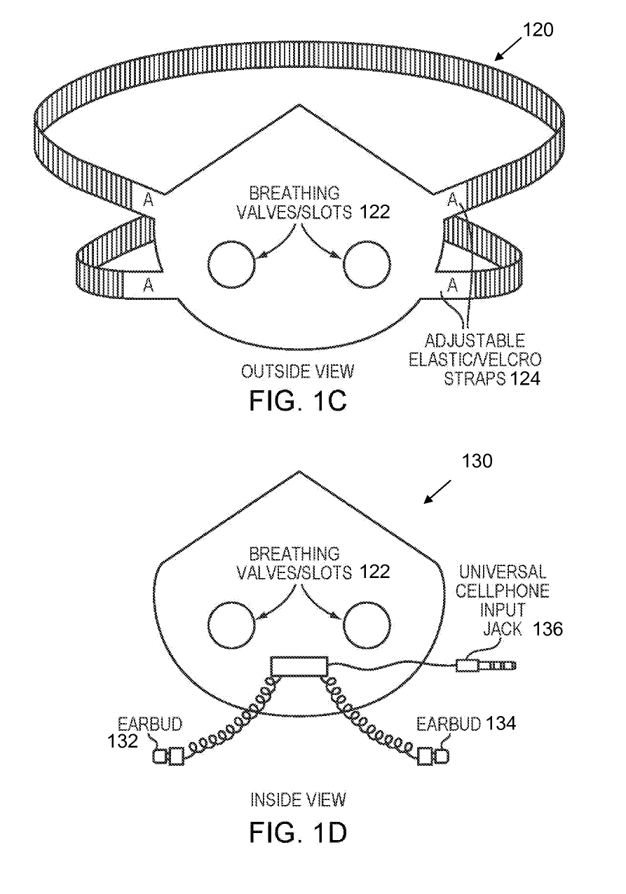

FIG. 2 is a schematic diagram 200 of an embodiment of a sound control device having five layers of a sound control device according to principles of the invention. The layers, from the inside to the outside, are a comfort level layer 202, a sound foam level layer 204, a foam cover level layer 206, a film level layer 208 and a printable cover level layer 210. A flap valve is shown penetrating all of the layers and fitting within a distance denoted D.

The layer that touches the skin is preferably a hypo-allergenic material that is comfortable to wear. In the space between the mask and the user's mouth is a microphone attached to this first layer. In some embodiments, the second layer is a soft, light sound absorbing material in sheet form, such as an expanded foam sheet. In some embodiments, the third layer is a container designed to contain the first and second layers. In one embodiment, the third layer can be a light fabric or a sheet of nonwoven material.

In some embodiments, the fourth layer is plastic film, used to reflect inward voice energy passing through the first, second and third layers.

In some embodiments, the fifth layer is a printable layer used to protect the plastic film. The fifth layer can be fabric and can be designed to display a color, a trademark, a logo, and/or advertising material. All of the layers together are formed into a soft cuplike structure that is worn over the lower face and that reduces audible voice levels within the structure from being overheard by a person who is not a party to a conversation or other communication with the user.

In some embodiments, all the layers are held together by glue or similar bonding material. In other embodiments, some or all of the layers can be held together by mechanical fastening, such as with thread or filamentary material. In other embodiments, combinations of mechanical fastening and bonding can be employed.

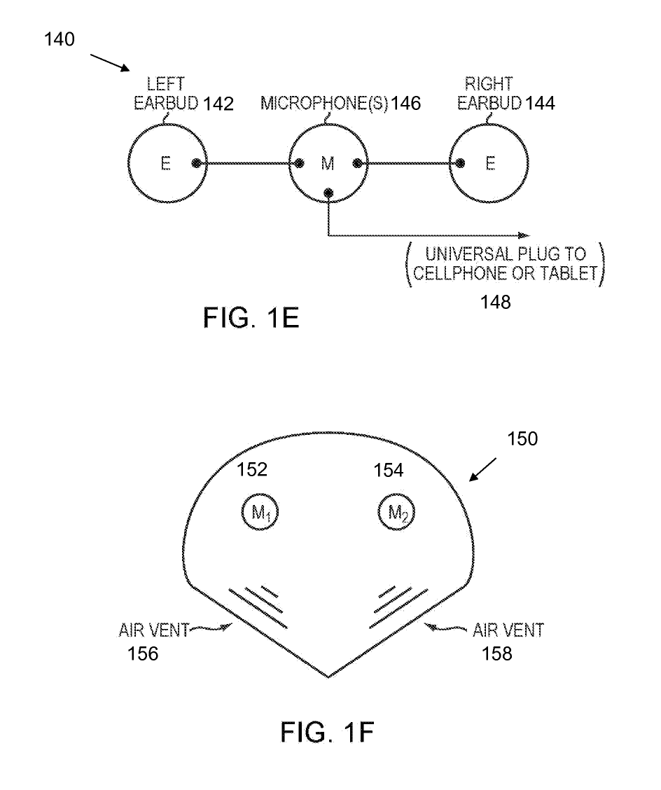

FIG. 3 is an illustration 300 of an interior surface of an embodiment of a sound control device according to principles of the invention. The sound control device has a number of mechanical elements 302, 304, 306, 308 that allow it to be fitted to the face of a user. Also illustrated are a breathing port 310, a microphone 312, and an electrical connector 314.

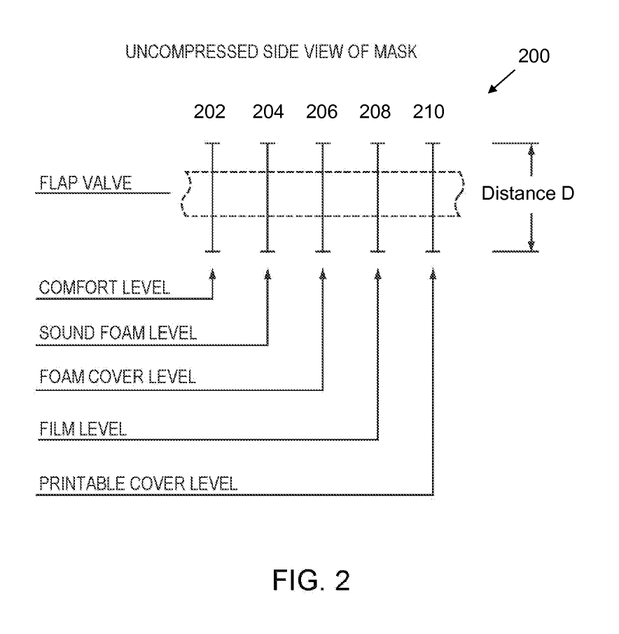

FIG. 4 is an illustration 400 of the exterior of an embodiment of a sound control device according to principles of the invention. As shown in FIG. 400 the sound control device is a mask-like structure with a breathing apparatus 410 provided therein.

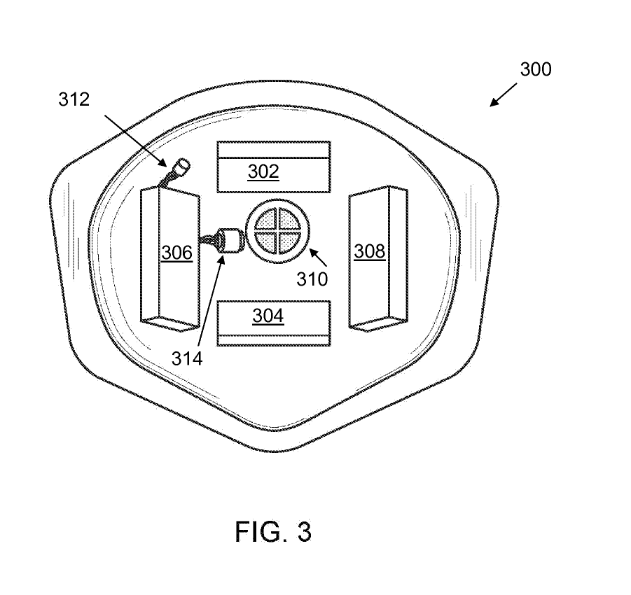

FIG. 5 is an illustration 500 of another embodiment of an external layer of a sound control device according to principles of the invention, showing the location of air vents 502, 504 and a location of an electrical input terminal 506. In the external layer 500 there in a raised region 510 which can house a microphone and electronics. The external layer can be fabricated from any convenient amerial. In a preferred embodiment, it is constructed of plastic.

A valve is provided to allow the user to easily and safely inhale or exhale breath without the various layers restricting breathing. In some embodiments the valve is a flap valve.

In an alternative embodiment, the device encloses the mouth, but does not enclose the nose. The device may or may not enclose the chin. In such a circumstance, a valve that would be provided to permit the user to breathe in comfort may be eliminated, because breathing through the nose is not affected by the device.

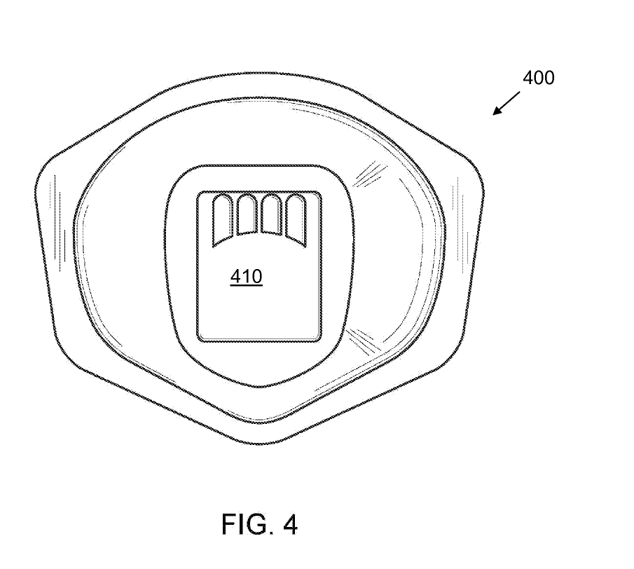

FIG. 6 is an illustration 600 in perspective of an embodiment of a sound control device according to principles of the invention situated on the face of a user.

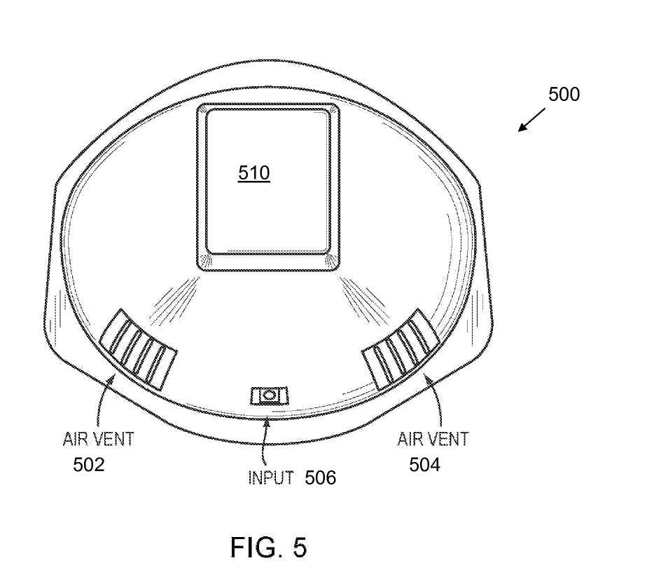

FIG. 7 is a frontal illustration 700 of an embodiment of a sound control device according to principles of the invention situated on the face of a user.

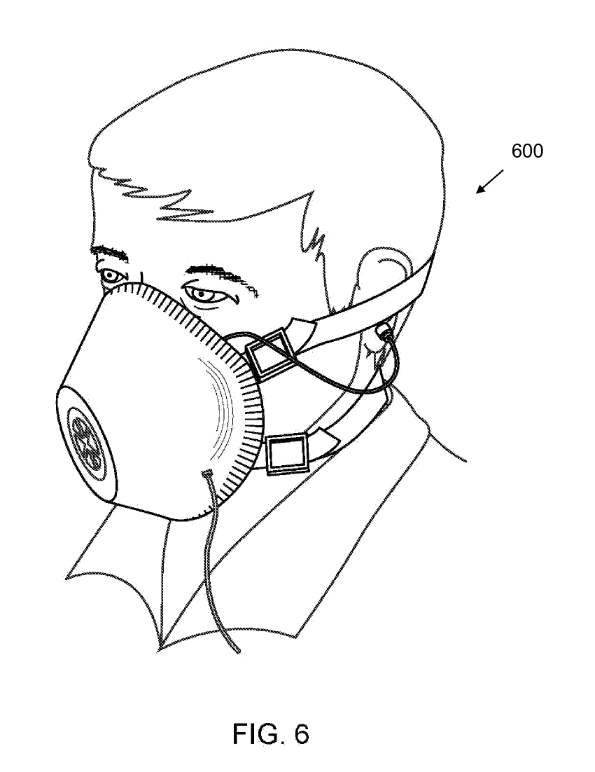

FIG. 8 is a schematic front view 800 of an embodiment of a sound control device according to principles of the invention showing a location 830 where a logo and/or trademark can be imprinted on the front of the device. The sound control device includes a breathing portal 810 and a strap 820 for holding the sound control device on the head of a user.

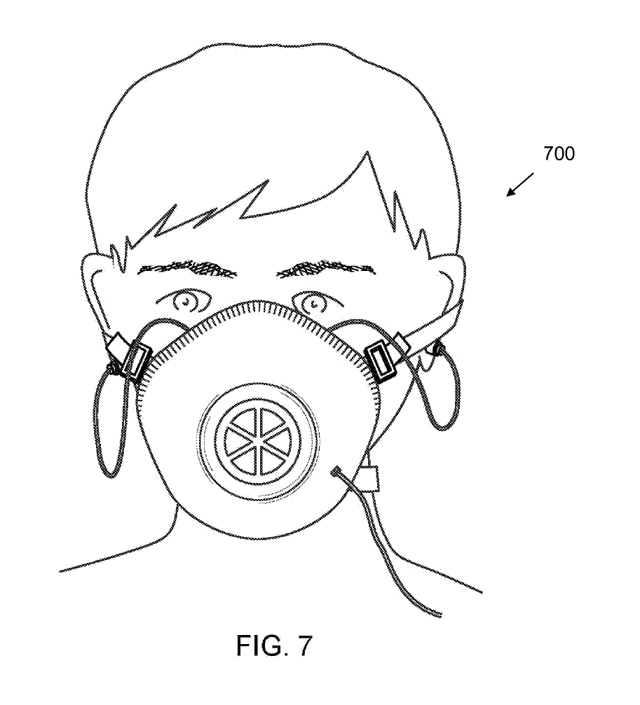

FIG. 9 is a frontal view 900 of an embodiment of a sound control device according to principles of the invention showing the external form of a molded housing 910 for the device and a strap 920. The strap can in one embodiment be an elastic band. The strap in another embodiment can be a strap in two parts that are connected using a hook and eye connector, such as Velcro™ material.

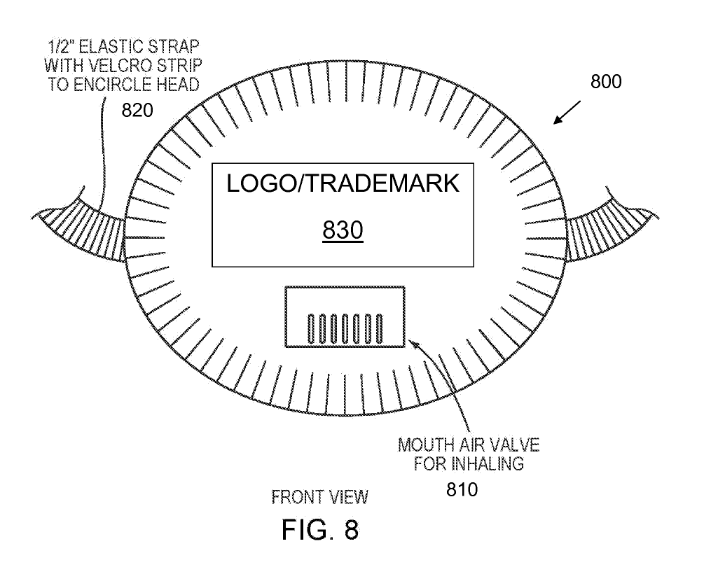

FIG. 10 is an interval view 1000 of an embodiment of a sound control device according to principles of the invention showing the electronic connector 1008, microphone 1006 and earbuds 1002, 1004 as well as sound insulation material (e.g., the plurality of layers that make up the device, as previously described with regard to FIG. 2.

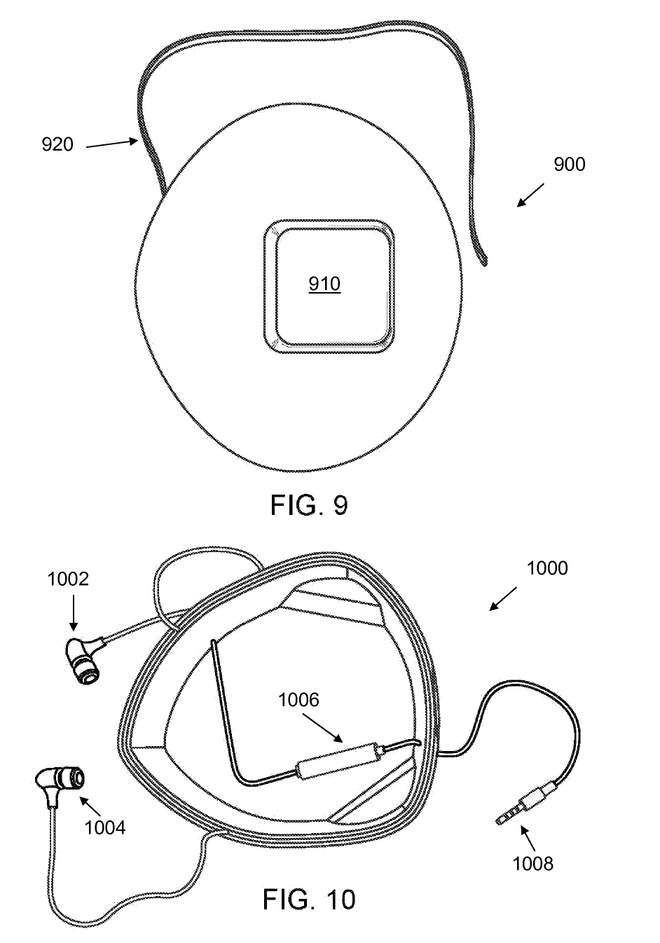

FIG. 11 is an interval view 1100 of an embodiment of a sound control device according to principles of the invention showing a covering 1106 that covers the microphone. Also illustrated are earbuds 1102, 1104, an electrical jack 1106 and a strap 1110.

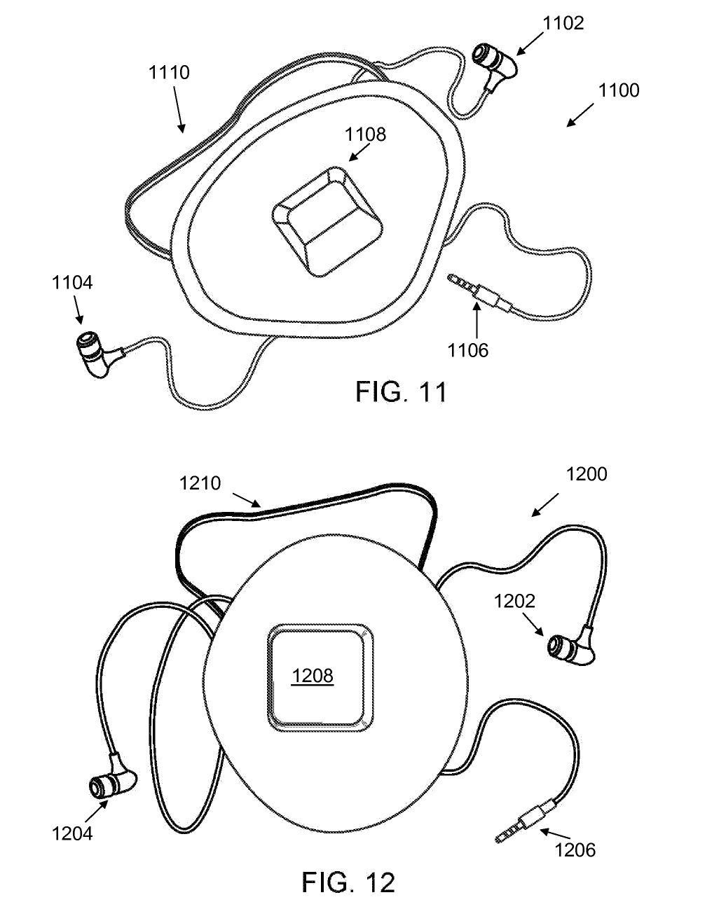

FIG. 12 is an external view 1200 of an embodiment of a sound control device according to principles of the invention showing the electronic connector 1206, a strap 1210 and earbuds 1202, 2104.

The device includes at least one electronic microphone that can receive oral utterances as an audible communication signal and generate therefrom an electrical signal representative of the oral utterances. In some embodiments, the microphone within the mask is connected by way of an electronic communication channel to an output terminal that can provide an electrical signal representative of the audible signal received by the microphone. In some embodiments, the electronic communication channel is an electrical cable. In other embodiments, the electronic communication channel is a wireless communication channel. The output terminal can be located on an external surface of the device, or can be provided at a distal end of an electrical cable that is connected to the device. The exact location of the output terminal is not critical, but preferably is a location where a connection can be made in a convenient manner.

The device includes at least one speaker that can receive an electrical signal representing a communication in the range of frequencies that are audible to humans, and that can generate a sound signal representative of the information contained in the electrical signal. In some embodiments, the speaker can be an earbud or an earphone. The information contained in the electrical signal can be a representation of a human voice, a computer generated electronic voice, an audible signal in an encoded form such Morse code, or any other audible signal that can convey information that a human can hear. The speaker is connected by way of an electronic communication channel to an input terminal that can receive an electrical signal representative of an audible signal to be generated by the speaker. In some embodiments, the electronic communication channel is an electrical cable. In some embodiments, the electronic communication channel is a wireless communication channel. The input terminal can be located on an external surface of the device, or can be provided at a distal end of an electrical cable that is connected to the device. The exact location of the input terminal is not critical, but preferably is a location where a connection can be made in a convenient manner.

In some embodiments, the output terminal and the input terminal are provided in a single unitary connector such as a commercially available 2.5 mm or 3.5 mm jack that can mate with a cellphone. In a wired-only system, the entire apparatus is self-contained and requires no external power other than that provided by connection to a cellphone.

In another embodiment, one or both of the microphone and the speaker are provided with wireless capability. In a purely wireless configuration, the single unitary connector is a wireless connector that provides a bi-directional communication connection to a cellphone using a standard low power, short range wireless communication protocol such as Bluetooth or Wi-Fi. A device that includes Bluetooth connectivity can be helpful in accommodating persons who use advanced hearing aids.

In a wireless configuration, it is necessary to provide power either by radio frequency communication from the connected cellphone, or by providing a battery in the device. If a battery is provided, a power terminal is provided to allow the battery to be recharged as needed. In some instances, the battery can be charged using an electromagnetic induction system, similar to those provided on some electric toothbrushes (such as the Ultrasonex toothbrush model 5C01 available from Sonex Corporation), or using a charger such as those provided to charge the handsets of cordless telephones (such as the AT&T model EL52200 cordless telephone available from AT&T).

In some embodiments, some of the connections can be configured as wired connections and other connections can be configured as wireless connections.

The device can allow the user to hear sounds generated by persons or things in the vicinity of the user, whether the device employs earbud speakers or Bluetooth connected speakers.

### DEFINITIONS

Unless otherwise explicitly recited herein, any reference to an electronic signal or an electromagnetic signal (or their equivalents) is to be understood as referring to a non-transitory electronic signal or a non-transitory electromagnetic signal.

### THEORETICAL DISCUSSION

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. An apparatus, comprising:
a structure configured to be worn by a human operator,
said structure configured to enclose at least a mouth of the human operator,
said structure configured to prevent an oral utterance of the human operator from being overheard by a listener who is not a party to a conversation with the human operator,
said structure configured to allow the human operator to breathe without restriction,
said structure configured to allow hands-free bi-directional oral communication by the human operator;
a microphone situated within said structure, said microphone configured to be positioned relative to the mouth of the human operator so as to capture said oral utterance of the human operator and to provide as output an electrical signal representative of said oral utterance, said microphone connected by way of a first communication channel to an output terminal that is configured to provide the output electrical signal;
at least one speaker configured to be in proximity to an ear of the human operator, the at least one speaker configured to provide an audible output signal to said ear of the human operator, the at least one speaker connected by way of a second communication channel to an input terminal, the input terminal configured to receive an input signal representative of the audible output signal; and
a single unitary connector configured to connect both the input terminal and the output terminal to an electronic communication device so as to provide bi-directional communication capability between the apparatus and the electronic communication device.

2. The apparatus of claim 1, wherein the electronic communication device is a cellular telephone handset.

3. The apparatus of claim 1, wherein the electronic communication device is configured to communicate using the Voice over Internet Protocol.

4. The apparatus of claim 1, wherein the electronic communication device is configured to communicate using a wireless electronic communication system.

5. The apparatus of claim 1, wherein the electronic communication device is configured to communicate using a wired electronic communication system.

6. The apparatus of claim 1, wherein at least one of the first communication channel, the second communication channel and the single unitary connector is configured as a wired connection.

7. The apparatus of claim 1, wherein at least one of the first communication channel, the second communication channel and the single unitary connector is configured as a wireless connection.

8. The apparatus of claim 1, wherein said at least one speaker configured to be in proximity to an ear of the human operator is configured to prevent said audible output signal from being overheard by a listener who is not a party to said conversation with the human operator.
